(19) United States
(12) Patent Application Publication
(10) Pub. No.: US 2015/0339915 A1
(43) Pub. Date: Nov. 26, 2015

(54) ADVANCED INTERCONNECTED SMOKE ALARM SYSTEM WITH CENTRALLY LOCATED BATTERY AND DC POWER SUPPLY

(71) Applicants: Brent Waterman, Heber City, UT (US); William Quapp, Heber City, UT (US)

(72) Inventors: Brent Waterman, Heber City, UT (US); William Quapp, Heber City, UT (US)

(21) Appl. No.: 14/285,615

(22) Filed: May 22, 2014

(51) Int. Cl. G08B 29/18; G08B 17/10

(52) U.S. Cl. CPC G08B 29/181; G08B 17/10

(57) ABSTRACT

A smoke detector system with a first DC power supply and a second DC power supply connected to at least one smoke detector wherein the first DC power supply may be powered by an AC power input and the second DC power supply may be a battery is disclosed. The smoke detectors may be powered primarily by the first DC power supply during normal operations. The second DC power supply may be configured to supply power to the one or more smoke detectors in the event of the loss of the AC power input to the first power supply.

### TECHNICAL FIELD

This invention relates to hazardous condition detectors. More specifically, this invention relates to smoke and other hazardous condition detectors.

### BACKGROUND OF THE INVENTION

Prior art smoke detector systems typically provide a battery located with the smoke detector. When the smoke detectors are located in hard to access areas, replacing the battery can be problematic. This can result in failure to maintain the smoke detector, and a loss of the smoke detector's function. It is well documented that many deaths due to fire can be attributed to improperly maintained and non-functional smoke detectors.

### SUMMARY OF THE INVENTION

Smoke detectors, a smoke detector system, a method of operating a smoke detector system, a method of maintaining a smoke detector system, and a method of retrofitting an existing smoke detector system are described. As used herein, smoke detector means a device that detects the presence of smoke in an enclosed space by any method and the detection of any other hazardous condition including but not limited to the detection of carbon monoxide, heat, temperature rise rate, radiation, and combinations thereof. The smoke detector system described herein may have a first DC power supply and a second DC power supply connected to at least one smoke detector wherein the first DC power supply may be powered by an AC power input and the second DC power supply may be a battery. The smoke detectors may be powered primarily by the first DC power supply during normal operations. The second DC power supply may be configured to supply power to the one or more smoke detectors in the event of the loss of the AC power input to the first power supply. The smoke detector system may further include an alarm system control module wherein the alarm system control module is connected to the first and second power supplies and the one or more smoke detectors. The alarm system control module may further include components including, but not limited to, an operational status communication circuit, a test button circuit, a hush button circuit, and combinations thereof. The smoke detector system may further include a signal wire connecting the alarm system control module and one or more smoke detectors. Each of the smoke detectors may further include an alarm, a smoke and hazardous detection circuit, and a power status indicator. The first DC power supply may be an AC to DC power converter. The second power supply may be a rechargeable battery. The first power supply may be configured to provide power to the second power supply.

The details of one or more implementations of a smoke detector and smoke detector system are set forth in the accompanying drawings and the description below. Other features, aspects, and advantages of a smoke detector and smoke detector system will become apparent from the description, the drawings, and the claims.

### BRIEF DESCRIPTION OF THE DRAWINGS

The following detailed description of the embodiments of the invention will be more readily understood when taken in conjunction with the following drawing, wherein:

FIG. 1 is a block diagram illustrating exemplary components for one embodiment of the smoke detector system of the present invention.

FIG. 2 is a block diagram illustrating exemplary components for an embodiment of the smoke detector system of the present invention that includes an alarm system control module.

FIG. 3 is a block diagram illustrating exemplary components for one embodiment of a smoke detector used in the smoke detector system of the present invention.

### DETAILED DESCRIPTION OF THE PREFERRED EMBODIMENTS

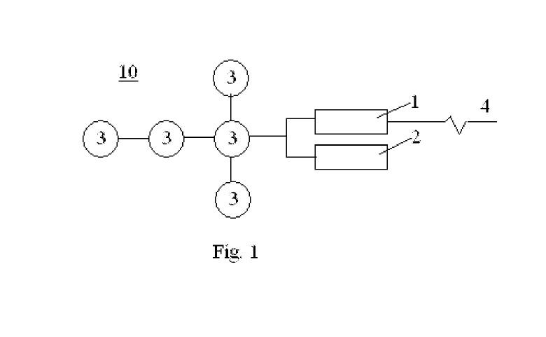

FIG. 1 is a block diagram illustrating exemplary components for one embodiment of the smoke detector system 10 of the present invention. A first DC power supply 1 and a second DC power supply 2 are connected to at least one smoke detector 3. The first DC power supply 1 is powered by an AC power input 4 and the second DC power supply 2 may be a battery. Preferably, but not meant to be limiting, the AC power input 4 is the voltage provided by the local utility serving the building the smoke detector system 10 is present in. For example, and not meant to be limiting, in the United States, the AC power input 4 would typically be 120 VAC building power. The AC power input 4 may provide power to DC power supply 1 which may then maintain the second DC power supply 2 at a constant maintenance voltage. For off-grid locations such as cabins located in remote areas where AC power is not available, the first DC power supply 1 and second DC power supply 2 may be replaced by a bank of suitably sized non-rechargeable batteries.

For off-grid locations such as cabins located in remote areas where AC power is not available, the first DC power supply 1 and second DC power supply 2 may be replaced by a bank of suitably sized rechargeable or non-rechargeable batteries. If rechargeable batteries are used, they could be recharged buy either a solar voltaic system or a generator. Non-Rechargeable batteries would require periodic replacement. With either rechargeable or non-rechargeable batteries, the smoke detector would still be operated on DC power and the batteries would still be located in a central, easily accessible location.

The smoke detectors 3 may be powered primarily by the first DC power supply 1 during normal operations. The second DC power supply 2 may be configured to supply power to the one or more smoke detectors 3 in the event of the loss of the AC power input 4 to the first power supply 1. While not meant to be limiting, the second DC power supply 2 may be configured such that in the event of the loss of the AC power input 4 to the first power supply 1, the second DC power supply 2 supplies power to the one or more smoke detectors 3 without the use of any mechanical or electrical switches or relays. In this manner, back up power from DC power supply 2 is more reliably supplied, as it cannot be interrupted by the failure of a mechanical or electrical switch or relay.

The first DC power supply 1 may be an AC to DC power converter. The second power supply 2 may be a rechargeable battery. The first power supply 1 may be configured to provide power to the second power supply 2. The second power supply 2 invention may eliminate the need for a battery installed in each smoke detector 3 by providing the second power supply 2 in a central and conveniently accessible location in a home or business, thereby facilitating testing, replacement of depleted batteries, and providing a hush feature whereby the smoke detectors 3 may also be silenced from a central and conveniently accessible location when a non-critical alarm condition occurs.

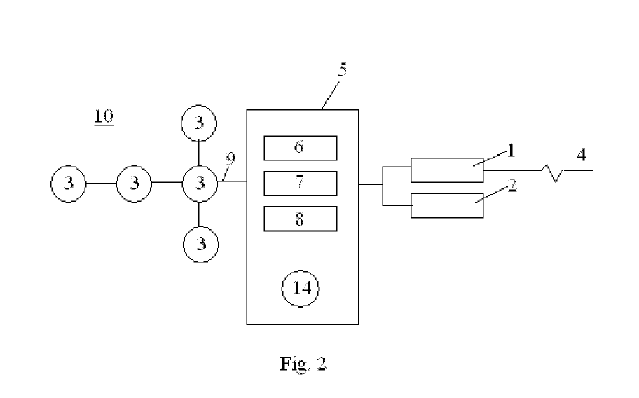

FIG. 2 is a block diagram illustrating exemplary components for an embodiment of the smoke detector system 10 of the present invention that includes an alarm system control module 5. The alarm system control module 5 may be connected to the first power supply 1 and the second power supply 2 and the one or more smoke detectors 3. The alarm system control module 5 may further include components including, but not limited to, an operational status communication circuit 6, a test button circuit 7, a hush button circuit 8, a test button 14, and combinations thereof. The smoke detector system may further include a signal wire 9 connecting the alarm system control module 5 and one or more smoke detectors 3.

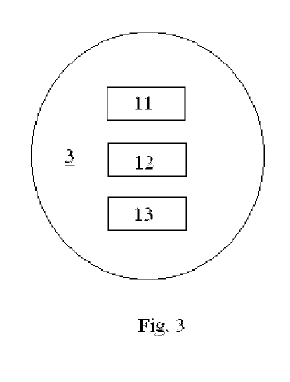

FIG. 3 is a block diagram illustrating exemplary components for one embodiment of a smoke detector 3 used in the smoke detector system 10 of the present invention. Each of the smoke detectors 3 may further include an audible alarm 11, a smoke and hazardous condition detection circuit 12, and a power status indicator 13. While not meant to be limiting, hazardous detection circuit 12 may be configured to detect smoke, carbon monoxide, other hazardous conditions, or combinations thereof using ionization methods, photoelectric methods, combined ionization and photoelectric methods, and combinations thereof.

DC power may be supplied to the smoke detectors 3 using standard wiring methods such as 14-3 NM, 12-3 NM or other National Electrical Code (NEC) approved wiring methods. Current commercially available smoke detectors may be replaced with the simplified design described herein to move functions such as the operational status communication circuit 6, a test button circuit 7, hush button circuit 8, alarm system control module 5 and battery replacement to a central location. With the appropriate modification of the smoke detectors described herein, existing structures may be retrofitted using existing wiring that may then be connected to one or more of the centrally located first DC power supply 1, second DC power supply 2 consisting of a battery and alarm system control module 5. A qualified homeowner or electrician may make these system modifications with a minimum of building electrical system modifications.

The smoke detector system 10 may also use the existing three wire circuitry commonly employed in interconnected systems to provide the power and the communication function between interconnected smoke detectors.

If desired, the smoke detector system 10 could also be interfaced to operate with other security and emergency notification systems.

For new construction, since the smoke detector system 10 may be implemented using only low voltage DC power as a Class 2 device that may use other NEC approved wiring methods for Class 2 devices. However, the smoke detector system 10 can be retrofitted into any residence or facility where the standard three wire smoke detector interconnect-wiring-protocol is used. The smoke detectors would be replaced by the low voltage DC smoke detectors shown in FIG. 3. If the current smoke detectors are on a dedicated circuit, the existing AC wiring may be hardwired from the circuit breaker panel to the first power supply 1. If the current smoke detectors are not on a dedicated circuit, the smoke detectors 3 may be disconnected from the AC circuit and connected to AC power via a hard wired connection as required by NFPA 72. These modifications can be readily implemented by a electrician or qualified homeowner. The 14-3 wire commonly used in the USA to interconnect smoke alarms may now carry the low voltage DC power. The original alarm signal wire may continue to be used for that purpose.

The centrally located battery back-up battery of the second power supply 2 may be much larger than the batteries (generally a 9 volt battery) used in current technology and will supply backup DC power to the smoke detectors 3 for a much longer period than the conventional 9 volt batteries. As an example, and not meant to be limiting, one rechargeable battery commonly used in computer backup power supplies has a capacity of 7.2 amp hours (Ah) of power. A representative alkaline 9 volt battery has a capacity of 565 mAh or 0.565 Ah. Thus, if the larger battery, as used in this example, was used to power a smoke detector 3, it would last almost 13 times as long for the same current draw.

Low battery charge warning circuitry may also be included in the centrally located battery pack to provide notification of battery degradation. Battery replacement intervals may be much longer and will vary according to the type and size of rechargeable battery used. With the power supply being located at a central location, the battery can be easily accessed and maintained compared to the effort required for the current design of commercially available smoke detectors mounted in locations required by NFPA 72.

Another advantage of smoke detector system 10 for new construction installations is the elimination of the costly 120V AC arc fault circuit protection for the smoke detector circuit in residences. Since low voltage power is now routed directly to the bedrooms and other smoke detector locations, this feature can eliminate the need for the arc fault circuit protection device as currently required by the NEC for smoke detector circuits providing an additional cost savings for new construction applications. Lower cost Class 2 wiring options are also available for Class 2 installations in new construction.

For off-grid applications, the back-up DC power source of power supply 2 may be implemented using a wide range of non-rechargeable battery technologies including a bank of standard 1.5 volt carbon-zinc, alkaline, or lithium batteries configured to provide the required DC voltage and operating power (milliamp storage capacity). Similarly, rechargeable battery bank of batteries (e.g., nickel-cadmium, nickel metal hydride, lithium iron disulfide, etc.), or from a rechargeable lead acid or similar battery such as used in uninterruptible power supplies may be used to provide the power in off-grid applications as long as periodic recharging such as from a solar panel or generator is performed.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

A number of implementations of the invention have been described. Nevertheless, it will be understood that various modifications can be made without departing from the spirit and scope of the invention.

1) A smoke detector system comprising a first DC power supply, a second DC power supply, and at least one smoke detector wherein the first DC power supply is powered by an AC power input and the second DC power supply is a battery and the first and second power supplies are both connected in parallel to the one or more smoke detectors.

2) The smoke detector system of claim 1 wherein the second DC power supply is configured to supply power to the one or more smoke detectors in the event of the loss of the AC power input to the first power supply.

3) The smoke detector system of claim 1 further comprising an alarm system control module wherein the alarm system control module is connected to the first and second power supplies and the one or more smoke detectors.

4) The smoke detector system of claim 3 wherein the alarm system control module further comprises components selected from an operational status communication circuit, a test button circuit, a hush button circuit, and combinations thereof.

5) The smoke detector system of claim 3 further comprising a signal wire connecting the alarm system control module and the one or more smoke detectors.

6) The smoke detector system of claim 1 wherein each of the one or more smoke detectors further comprise an alarm, a smoke and hazardous detection circuit, and a power status indicator.

7) The smoke detector system of claim 1 wherein the first DC power supply is an AC/DC converter.

8) The smoke detector system of claim 1 wherein the second power supply is a rechargeable battery.

9) The smoke detector system of claim 8 wherein the first power supply is configured to provide power to the second power supply.

10) A smoke detector system comprising a first DC power supply, a second DC power supply, at least one smoke detector, and an alarm system control module, wherein the first DC power supply is powered by an AC power input and the second DC power supply is a battery and the first and second power supplies are both connected in parallel to the one or more smoke detectors and wherein the alarm system control module is connected to the first and second power supplies and the one or more smoke detectors.

11) The smoke detector system of claim 10 wherein the second DC power supply is configured to supply power to the one or more smoke detectors in the event of the loss of the AC power input to the first power supply.

12) The smoke detector system of claim 10 wherein the alarm system control module further comprises components selected from an operational status communication circuit, a test button circuit, a hush button circuit, and combinations thereof.

13) The smoke detector system of claim 12 further comprising a signal wire connecting the alarm system control module and the one or more smoke detectors.

14) The smoke detector system of claim 10 wherein each of the one or more smoke detectors further comprise an alarm, a smoke and hazardous detection circuit, and a power status indicator.

15) The smoke detector system of claim 10 wherein the first DC power supply is an AC to DC power converter.

16) The smoke detector system of claim 10 wherein the second power supply is a rechargeable battery.

17) The smoke detector system of claim 16 wherein the first power supply is configured to provide power to the second power supply when AC power is available.

18) A smoke detector system comprising a first DC power supply, a second DC power supply, at least one smoke detector, an alarm system control module, and a signal wire wherein the first DC power supply is powered by an AC power input and the second DC power supply is a battery and the first and second power supplies are both connected to the one or more smoke detectors and wherein the alarm system control module is connected to the first and second power supplies and the one or more smoke detectors and the signal wire connects the alarm system control module and the one or more smoke detectors.

19) The smoke detector system of claim 18 wherein the second DC power supply is configured to supply power to the one or more smoke detectors in the event of the loss of the AC power input to the first power supply.

20) The smoke detector system of claim 18 wherein the alarm system control module further comprises components selected from an operational status communication circuit, a test button circuit, a hush button circuit, and combinations thereof.

21) The smoke detector system of claim 18 wherein each of the one or more smoke detectors further comprise an alarm, a smoke and hazardous detection circuit, and a power status indicator.

22) The smoke detector system of claim 18 wherein the first DC power supply is an AC to DC power converter.

23) The smoke detector system of claim 18 wherein the second power supply is a rechargeable battery.

24) The smoke detector system of claim 18 wherein the first power supply is configured to provide power to the second power supply.
